(19) United States
(12) Patent Application Publication
(10) Pub. No.: US 2010/0071595 A1
(43) Pub. Date: Mar. 25, 2010

(54) WATER-BASED SETTING AND HARDENING ACCELERATOR FOR HYDRAULIC BINDERS AND PROCESS FOR PRODUCING IT

(75) Inventors: Benedikt Lindlar, Konstanz (DE); Franz Wombacher, Oberlunkhofen (CH); Heinz Schurch, Gontenschweil (CH); Urs Mader, Frauenfeld (CH)

Correspondence Address: BINGHAM MCCUTCHEN LLP, 2020 K Street, N.W., Intellectual Property Department, WASHINGTON, DC, 20006, US

(73) Assignee: Sika Technology AG

(21) Appl. No.: 12/391,775

(22) Filed: Feb. 24, 2009

Related U.S. Application Data
(63) Continuation of application No. 10/588,284, now abandoned.

(30) Foreign Application Priority Data
Feb. 6, 2004 (EP) 04002676.7

(51) Int. Cl. C04B 22/06; C04B 24/04; C04B 14/48

(52) U.S. Cl. 106/640; 106/823; 106/801; 106/810

(57) ABSTRACT

A water-based coagulating and hardening accelerator for hydraulic binding agents, comprising sulfate, aluminum and organic acid. The molar ratio of aluminum to organic acid is less than 0.65. Preferably, the molar ratio of aluminum to carboxylic acid is less than 0.60 and greater than 0.38.

This application is a continuation of application Ser. No. 10/588,284, filed on Aug. 4, 2006. This application claims the priority of PCT Application No. PCT/EP2005/050497, filed Feb. 4, 2005 and European Application No. 04002676.7, filed on Feb. 6, 2004, the disclosure of which is incorporated herein by reference in its entirety.

### TECHNICAL FIELD

The invention relates to a setting and hardening accelerator for hydraulic binders according to the preamble of the first claim.

The invention likewise relates to a process for producing a setting and hardening accelerator for hydraulic binders according to the preamble of the independent process claim.

### PRIOR ART

Many substances which accelerate the setting and hardening of concrete are known. Customarily used substances are, for example, strongly alkaline substances such as alkali metal hydroxides, alkali metal carbonates, alkali metal silicates, alkali metal aluminates and alkaline earth metal chlorides. However, in the case of the strongly alkaline substances, undesirable effects on the processor, e.g. burns, can occur and they reduce the final strength and the durability of the concrete.

EP 0 076 927 B1 discloses alkaline-free setting accelerators for hydraulic binders, which are said to avoid these disadvantages. To accelerate the setting and hardening of a hydraulic binder such as cement, lime, hydraulic lime, and gypsum, and also mortar and concrete produced therefrom, from 0.5 to 10% by weight, based on the weight of the binder, of an alkali-free setting and hardening accelerator containing aluminum hydroxide is added to the mixture containing said binder.

Such mortars and concretes are, due to the accelerated setting and hardening, particularly useful as sprayed mortar and concrete.

EP 0 946 451 B1 discloses setting and hardening accelerators in dissolved form for hydraulic binders, which can be more easily mixed into the concrete when the concrete is sprayed. Such a setting and hardening accelerator comprises, inter alia, aluminum hydroxide, aluminum salts and organic carboxylic acids.

Such known accelerators contain a relatively large amount of aluminum salts and amorphous aluminum hydroxide, which is very expensive, is required for producing them. To make the production of such accelerators possible, the water for the reaction has to be heated to about 60-70° C. In addiction further disadvantages of such setting and hardening accelerators are a relatively low early strength in the first hours and days and un-satisfactory stability of the solution.

### BRIEF DESCRIPTION OF THE INVENTION

It is an object of the invention to achieve very high early strength combined with very long stability of the accelerator for a water-based setting and hardening accelerator for hydraulic binders of the type mentioned at the outset.

According to the invention, this is achieved by the features of the first claim.

The advantages of the invention are, inter alia, that a high stability, i.e. stabilization of the accelerator solution, is achieved by means of the accelerators of the invention and that high strengths are achieved in the first hours and days.

Further advantageous embodiments of the invention are disclosed in the description and the subordinate claims.

### PERFORMANCE OF THE INVENTION

Water-based setting and hardening accelerators according to the invention for hydraulic binders can be produced in various ways, with the molar ratio of aluminum to the organic acid being less than 0.65.

The term “water-based accelerator” here refers to an accelerator which can be in the form of a solution containing to some extent finely dispersed particles or in the form of a dispersion.

Such a water-based setting and hardening accelerator according to the invention advantageously comprises (in % by weight):
from 14.4 to 24.9% of sulfate,
from 4 to 9.7% of aluminum (or from 7.6 to 18.3% of Al₂O₃),
12-30% of organic acid,
0-10% of alkaline earth metal,
0-10% of alkanolamine,
0-5.0% of plasticizer,
0-20% of stabilizer,
and water, with the molar ratio of aluminum to the organic acid being less than 0.65.

The aluminum content reported as Al₂O₃ is preferably less than 14%, particularly preferably less than 13% and in particular less than 12%, of Al₂O₃.

The abovementioned substances are advantageously present as ions in solution but can also be present in complexed form or undissolved form in the accelerator. This is the case especially when the accelerator is in the form of a solution containing to some extent finely dispersed particles or in the form of a dispersion.

A water-based setting and hardening accelerator according to the invention for hydraulic binders can be produced, for example, from Al₂(SO₄)₃ aluminum sulfate, Al(OH)₃ aluminum hydroxide and organic acid in aqueous solution, with the molar ratio of aluminum to the organic acid being less than 0.65.

To produce a preferred water-based setting and hardening accelerator according to the invention, use is advantageously made of (in % by weight):
30-50% of Al₂(SO₄)₃ aluminum sulfate,
5-20% of Al(OH)₃ aluminum hydroxide,
12-30% of organic acid,
0-10% of alkaline earth metal hydroxide,
0-10% of alkaline earth metal oxide,
0-10% of alkanolamine,
0-5.0% of plasticizer,
0-20% of stabilizer,
balance water, with the molar ratio of aluminum to the organic acid being less than 0.65.

Preferably, an aluminum sulfate containing about 17% of Al₂O₃ is used, but it is also possible to use other contents, although the amounts to be added then may have to be adapted accordingly. The aluminum sulfate can also be produced by reaction of aluminum hydroxide with sulfuric acid in the production of the accelerator, with sulfate ions correspondingly being formed in the aqueous solution. In general, aluminum sulfate can be produced by reaction of a basic aluminum compound with sulfuric acid.

Amorphous aluminum hydroxide is advantageously used as aluminum hydroxide. The aluminum hydroxide can also be used in the form of aluminum hydroxide carbonate, aluminum hydroxysulfate or the like.

As organic acid, preference is given to using a carboxylic acid, particularly preferably formic acid, but it is also possible to use other organic acids having an equivalent effect, e.g. acetic acid. In general, it is possible to use all monoprotic or multi-protic carboxylic acids.

Since sulfate is used in the accelerator, magnesium hydroxide Mg(OH)₂ is preferably used as alkaline earth metal hydroxide. The same applies to the alkaline earth metal oxide, so that magnesium oxide MgO is then preferably used.

Diethanolamine DEA is advantageously used as alkanol-amine.

As plasticizer, use is advantageously made of polycarboxylates, particularly advantageously Sika ViscoCrete®.

Silica sol is advantageously used as stabilizer.

To produce particularly advantageous setting and hardening accelerators, use is made essentially of (in % by weight):
from 30-50% of Al₂(SO₄)₂ aluminum sulfate, preferably 35-45%, in particular 35-38%, and/or
5-20% of Al(OH)₃ aluminum hydroxide, in particular 7-15%, and/or
15-23% of organic acid and/or
1-10% of alkaline earth metal hydroxide, in particular 2-6%, and/or
1-5% of alkaline earth metal oxide and/or
1-3% of alkanolamine and/or
0.1-3.0% of plasticizer, in particular from 0.1 to 1.0%, and/or
0-10% of stabilizer,
balance water, with the molar ratio of aluminum to the organic acid being less than 0.65, preferably less than 0.60, particularly preferably less than 0.55 and in particular less than 0.50.

The molar ratio of aluminum to the organic acid is preferably in the range from 0.38 to 0.65, particularly preferably in the range from 0.38 to 0.60, in particular from 0.50 to 0.60. Below a value of 0.38, the pH becomes relatively low and a very high proportion of acid has to be used; in addition, the stability is sometimes no longer ensured.

Compared to conventional setting accelerators, the amount of the aluminum sulfate used for producing the accelerator and, in particular, the amount of aluminum hydroxide are reduced by up to 10% and 38%, respectively. In the production of the accelerator, preference is given to using up to 10% of magnesium hydroxide and/or a corresponding amount of magnesium oxide. The pure Mg amount based on the total amount of accelerator is from 0 to 4.2%, preferably from 0.8 to 2.9%, particularly preferably from 1.3 to 2.1%.

The ratio of aluminum to the organic acid is set to a value of less than 0.65, preferably less than 0.60, as a result of the increased organic acid content compared to known accelerators and the pH is set to 3-4 by means of up to 5% of alkanolamine.

The reduction by up to 25% in the amount of the aluminum used in the production of the accelerator improves the sulfate resistance. This is an advantage over conventional accelerators in the case of which the sulfate resistance is drastically worsened by the accelerator. The reduction in the sulfate resistance due to introduction of aluminum is caused especially by the aluminate phases having a particular affinity for sulfate. The additional aluminum increases the proportion of aluminate phases in the concrete, which then in the event of external sulfate acting on the cured concrete cause a not insignificant crystallization pressure due to ettringite formation and thus lead to damage. The aluminum content reported as Al₂O₃ is therefore preferably kept below 14%, particularly preferably below 13% and in particular below 12%, of Al₂O₃.

If magnesium hydroxide and/or oxide is used in the production of the accelerator, the temperature of the mixture rises as a result of the vigorous reaction of the magnesium hydroxide and/or oxide with the organic acid to such an extent that the water for these mixes does not have to be heated. The further components are then added to this heated mixture. However, the components can also be added in any other order. This simplifies the process and less energy is required. An additional advantage of the use of magnesium is the significantly increased storage stability of the accelerators brought about by the magnesium ions. Even at a content of 1% by weight of magnesium hydroxide in the production of the accelerator, good storage stability is achieved. At higher contents, the storage stability is at least four months. The use of magnesium hydroxide and/or oxide also enables the accelerator to be produced significantly more cheaply since expensive aluminum hydroxide can be replaced. In addition, the stability of the accelerators is positively influenced by the reduced amount of aluminum. The sulfate resistance is also increased by the reduced amount of aluminum.

The development of the compressive strength of the sprayed concrete in the first hours and days is also influenced very positively and is better than in the case of conventional accelerators.

### EXAMPLES

A number of samples of accelerators according to the invention were produced in accordance with the values indicated in Table 1, using aluminum sulfate containing 17% of Al₂O₃ and amorphous aluminum hydroxide, and compared with a comparative example B1 of a conventional accelerator.

TABLE 1
Sample composition in % by weight

| | | | Al₂(SO₄)₃ | | | |
|---|---|---|---|---|---|---|
| | | | (17% of | | HCOOH | |
| Example | H₂O | Al(OH)₃ | Al₂O₃) | Mg(OH)₂ | (85%) | DEA |
| A1 | 17.20 | 15.00 | 41.00 | 1.30 | 22.50 | 3.00 |
| A2 | 22.50 | 10.00 | 41.00 | 5.00 | 18.50 | 3.00 |
| A3 | 25.00 | 13.50 | 37.00 | 1.30 | 20.50 | 2.70 |
| A4 | 28.00 | 10.00 | 37.00 | 4.50 | 17.50 | 3.00 |
| A5 | 19.8 | 15.0 | 41.2 | 0.0 | 22.5 | 3.0 |
| A6 | 26 | 10 | 37 | 4.5 | 19.5 | 3 |
| A7 | 20.5 | 10 | 37 | 4.5 | 25 | 3 |
| A8 | 15.5 | 10 | 37 | 4.5 | 30 | 3 |
| B1 | 23 | 16 | 41 | 0 | 10 | 0 |
| (L53AF) | | | | | | |

To produce the accelerators A1 to A4 and A6 to A8, water is initially provided in unheated form. The magnesium hydroxide is slurried therein and formic acid is added, resulting in a large increase in the temperature. The aluminum hydroxide, the aluminum sulfate and the diethanolamine DEA are then added. The total mixture is then stirred until the reaction has abated and the temperature has dropped to about 40° C. after about one hour. This results in a solution which, depending on the composition, can also contain finely dispersed particles.

To produce the accelerator A5 without magnesium hydroxide or oxide, water was initially charged in preheated form. The formic acid is added to the water and the aluminum hydroxide is then added. The aluminum sulfate and the diethanolamine are then added. The total mixture is stirred until the reaction has abated.

Table 2 shows the molar ratios of aluminum to sulfate and of aluminum to the organic acid, here formic acid, of the samples measured. The values of the molar ratios of aluminum to the organic acid are below 0.67, preferably below 0.60. The aluminum content is also given for the various examples.

TABLE 2
Molar ratios

| | | Al/organic | | |
|---|---|---|---|---|
| Example | Al/sulfate | acid | % of Al | % of Al₂O₃ |
| A1 | 2.717 | 0.658 | 7.6 | 14.3 |
| A2 | 2.256 | 0.664 | 6.3 | 11.9 |
| A3 | 2.713 | 0.65 | 6.8 | 12.9 |
| A4 | 2.356 | 0.662 | 5.9 | 11.2 |
| A5 | 2.710 | 0.659 | 7.6 | 14.4 |
| A6 | 2.356 | 0.594 | 5.9 | 11.2 |
| A7 | 2.356 | 0.463 | 5.9 | 11.2 |
| A8 | 2.356 | 0.386 | 5.9 | 11.2 |
| B1 | 2.809 | 1.53 | 7.9 | 14.8 |

From 0.1 to 10% by weight of the accelerator according to the invention can be added to hydraulic binders.

To determine the effectiveness of the accelerator according to the invention of Examples A1 to A6 and of Comparative Example B1, a conventional concrete mixture for use as sprayed concrete was in each case admixed with 6% of the accelerator, based on the content of the hydraulic binder. Portland cement was used as hydraulic binder. The accelerator was in each case introduced in the region of the spray nozzle during processing of the sprayed concrete. After application of sprayed concrete, the strength of the sprayed concrete was determined. For this purpose, drill cores having dimensions of 5×5 cm are taken from the concrete. The compressive strength of the drill cores is then determined by means of a hydraulic press.

It has surprisingly been found that due to the high proportions of organic acid and magnesium and despite the reduced aluminum content, the strengths after from a few hours to a few days are much better than in the case of conventional accelerators, see Table 3. Although Example A5 displays a relatively high strength after one day, this is at significantly higher aluminum contents than in Examples A6 to A8. Embodiments in accordance with Examples A4 and A6 to A7 are thus particularly preferred, since the sulfate resistance is also improved by the lower Al content.

TABLE 3
Strengths in N/mm²

| | Example | | | | | | | | |
|---|---|---|---|---|---|---|---|---|---|
| | A1 | A2 | A3 | A4 | A5 | A6 | A7 | A8 | B1 |
| Strength | 18.3 | 16.3 | 14.9 | 16.6 | 20 | 20.5 | 20.6 | 19.5 | 12 |
| (MPL) | | | | | | | | | |
| after | | | | | | | | | |
| one day | | | | | | | | | |
| Strength | 47.5 | 40.4 | 45.5 | 48.1 | 48 | 48.5 | 49 | 47 | 42.1 |
| (MPL) | | | | | | | | | |
| after | | | | | | | | | |
| seven | | | | | | | | | |
| days | | | | | | | | | |

The accelerators of the invention can also be used for hydraulic binders other than cement, for example mixed cements, lime, hydraulic lime, and gypsum, and also mortar and concrete produced therefrom.

Of course, the invention is not restricted to the examples presented and described.

1. A water-based setting and hardening accelerator for hydraulic binders, comprising sulfate, aluminum and organic acid, with the molar ratio of aluminum to the organic acid being less than 0.65.

2. The water-based setting and hardening accelerator as claimed in claim 1, characterized in that it comprises (in % by weight): from 14.4 to 24.9% of sulfate, from 4 to 9.7% of aluminum and 12-30% of organic acid.

3. The water-based setting and hardening accelerator as claimed in claim 2, characterized in that the Al content of the accelerator reported as Al₂O₃ is less than 14% and/or less than 13% and/or less than 12% of Al₂O₃.

4. The water-based setting and hardening accelerator for hydraulic binders as claimed in claim 1, which can be produced from at least aluminum sulfate (Al₂(SO₄)₃) and/or sulfuric acid, aluminum hydroxide (Al(OH)₃) and organic acid, with amorphous aluminum hydroxide being particularly preferably used as aluminum hydroxide.

5. The water-based setting and hardening accelerator as claimed in claim 1, characterized in that the molar ratio of aluminum to the organic acid is less than 0.60, in particular less than 0.55.

6. The water-based setting and hardening accelerator as claimed in claim 1, characterized in that the molar ratio of aluminum to the organic acid is greater than 0.38.

7. The water-based setting and hardening accelerator as claimed in claim 1, characterized in that (in % by weight) the proportion of aluminum sulfate used in production of the accelerator is 30-50% and/or the proportion of aluminum hydroxide is 5-20% and/or the proportion or organic acid is 12-30%.

8. The water-based setting and hardening accelerator as claimed in claim 1, characterized in that it comprises (in % by weight): from 0 to 4.2% and/or from 0.8 to 2.9% and/or from 1.3 to 2.1% of alkaline earth metal.

9. The water-based setting and hardening accelerator as claimed in claim 1, characterized in that (in % by weight) 1-10% alkaline earth metal hydroxide and/or 1-10% of alkaline earth metal oxide are present in the production of the accelerator.

10. The water-based setting and hardening accelerator as claimed in claim 8, characterized in that the alkaline earth metal is magnesium.

11. The water-based setting and hardening accelerator as claimed in claim 1, characterized in that (in % by weight) 0-10% of alkanolamine and/or 0-5.0% of plasticizer and/or 0-20% of stabilizer are present in the production of the accelerator.

12. The water-based setting and hardening accelerator as claimed in claim 1, characterized in that the pH of the accelerator is in the range from 3 to 4.

13. The water-based setting and hardening accelerator as claimed in claim 1, characterized in that the organic acid component comprises a formic acid and/or an acetic acid.

14. A process for producing a setting and hardening accelerator as claimed in claim 1, characterized in that in the production of the aqueous solution and the addition of the components in the production of the solution the solution heats up to a temperature in the range from room temperature to 100° C.

15. A process for producing a setting and hardening accelerator as claimed in claim 1, characterized in that alkaline earth metal hydroxide and/or alkaline earth metal oxide, organic acid and the further components are added in any order to water, resulting in the mixture heating up substantially.

16. The process for producing a setting and hardening accelerator as claimed in claim 15, characterized in that aluminum sulfate is produced by reaction of a basic aluminum compound with sulfuric acid.

17. The process for producing a setting and hardening accelerator as claimed in claim 15 or 16, characterized in that the mixture heats up to a temperature of up to 100° C.

18. The process for producing a setting and hardening accelerator as claimed in claim 15 or 16, characterized in that the water is initially provided in unheated form.

19. A method of accelerating the setting and hardening of hydraulic binders and also of mortar or concrete produced therefrom, characterized in that a mixture comprising hydraulic binders is admixed with a setting and hardening accelerator as claimed in any of claim 1 in an amount of from 0.1 to 10% by weight, based on the weight of the hydraulic binder.

20. The use of the setting and hardening accelerator as claimed in any of claim 1 in a sprayed concrete or sprayed mortar.
